(19) United States
(12) Patent Application Publication
(10) Pub. No.: US 2015/0303862 A1
(43) Pub. Date: Oct. 22, 2015

(54) INTERACTIVE PHOTOVOLTAIC DEVICE AND INTERACTIVE PHOTOVOLTAIC SYSTEM

(71) Applicant: Generalplus Technology Inc., Hsinchu City (TW)

(72) Inventors: Li Sheng LO, Zhubei City (TW); Chih-Sung LIN, Taichung City (TW); Chi Che KUNG, Kaohsiung City (TW); Cheng-Chiang LIU, Hsinchu County (TW)

(21) Appl. No.: 14/618,924

(22) Filed: Feb. 10, 2015

(30) Foreign Application Priority Data
Apr. 16, 2014 (TW) 103113795

(51) Int. Cl. H01L 31/04; G05B 15/02; H02J 1/00

(52) U.S. Cl. CPC H02S 10/00; H02J 1/00; G05B 15/02

(57) ABSTRACT

An interactive photovoltaic device and an interactive photovoltaic system are provided. The interactive photovoltaic device communicates with a mobile device without any external power and battery. The mobile device has a display panel. The interactive photovoltaic device includes a case, a solar panel, an optical signal receiver and a control circuit. The solar panel is disposed on a first area of a bottom of the case. The optical signal receiver is disposed on a second area of the bottom of the case. When the mobile device executes interactive software and the interactive photovoltaic device is disposed on the display panel of the mobile device, the interactive photovoltaic device receives display panel light through the solar panel to enable the control circuit, and the control circuit receives an optical signal through the optical signal receiver, and decodes the optical signal to obtain an interactive instruction inputted by a user.

This application claims priority of No. 103113795 filed in Taiwan R.O.C. on 16 Apr. 2014 under 35 USC 119, the entire content of which is hereby incorporated by reference.

### BACKGROUND OF THE INVENTION

1. Field of the Invention

The present invention relates to the photovoltaic and light transmission application technology, and more particularly to an interactive photovoltaic device and an interactive photovoltaic system.

2. Related Art

Toys are articles for the children playing games. Toys are supports for the children to convert the mental processes, such as imagination, thinking and the like, into the behaviors. The children's toys are helpful to the exercise capacity developing, perception training, imagination exciting and curiosity arousing, and provide the substance condition for the children's physical and mental development. At present, most electronic toys available from the market operate independently or in a remotely controlled manner, and there are also some intelligent toys possessing the interactive functions. However, these interactive functions are typically presented on the reaction generated upon the human's touch or on the audio answering.

Recently, due to the popularization of the smart handheld device, many interactive electronic toys are designed to perform the interaction in conjunction with the smart handheld device. Typically, the interactive electronic toy or device capable of performing the communication and control with the tablet computer or smart mobile phone needs an additional electric power source. Generally speaking, such a type of interactive electronic toy needs to be powered by the additional battery, and performs the connection and control with the smart handheld device through wireless signals. Another type of interactive electronic toy has no battery built therein. This interactive electronic toy without the build-in battery needs to be electrically connected to the smart handheld device through a physical wire, such as the universal serial bus (USB) and to draw the power of the smart handheld device. In addition, the user can control the interactive electronic toy through the smart handheld device and the physical wire.

Usually, the interaction electronic device, having no self power and being connected to the tablet computer or the smart mobile phone to obtain the power through the physical wire, only can be connected to one single interactive electronic toy device. The reason resides in that the typical smart handheld device, such as the tablet computer or the smart mobile phone, only has an external universal serial bus connection port (or Thunderbolt Lightning connection port). In addition, because the battery contamination has the features of the long cycle and the large concealment, its potential hazards are very serious.

In view of this, the applicants have paid attention to the test and research based on the spirit of perseverance, and finally invented the “interactive photovoltaic device and interactive photovoltaic system” to be described in the following.

### SUMMARY OF THE INVENTION

An object of the present invention is to provide an interactive photovoltaic device and an interactive photovoltaic system, wherein the interactive photovoltaic device and a mobile device can perform communication and control without any battery and connection wire.

In view of this, the present invention provides an interactive photovoltaic device for communicating with a mobile device without any external power and battery, wherein the mobile device has a display panel. The interactive photovoltaic device comprises a case, a solar panel, an optical signal receiver and a control circuit. The solar panel is disposed on a first area of a bottom of the case. The optical signal receiver is disposed on a second area of the bottom of the case. The control circuit comprises a power input terminal and an input/output port, wherein the power input terminal is coupled to the solar panel to receive a power voltage, and the input/output port is coupled to the optical signal receiver.

When the mobile device executes interactive software, a first predetermined area of the display panel of the mobile device emits display panel light, and a second predetermined area of the display panel of the mobile device outputs an optical signal according to an interactive instruction inputted by a user. When the interactive photovoltaic device is disposed on the display panel of the mobile device, the interactive photovoltaic device enables the control circuit through the display panel light of the first predetermined area received by the solar panel. The control circuit receives the optical signal through the optical signal receiver, and decodes the optical signal to obtain the interactive instruction inputted by the user.

The present invention further provides an interactive photovoltaic system. The interactive photovoltaic system comprises a mobile device and an interactive photovoltaic device. The mobile device has a display panel. The interactive photovoltaic device communicates with the mobile device without any external power and battery. The interactive photovoltaic device comprises a case, a solar panel, an optical signal receiver and a control circuit. The solar panel is disposed on a first area of a bottom of the case. The optical signal receiver is disposed on a second area of the bottom of the case. The control circuit comprises a power input terminal and an input/output port, wherein the power input terminal is coupled to the solar panel to receive a power voltage, and the input/output port is coupled to the optical signal receiver.

When the mobile device executes interactive software, a first predetermined area of the display panel of the mobile device emits display panel light, and a second predetermined area of the display panel of the mobile device outputs an optical signal according to an interactive instruction inputted by a user. When the interactive photovoltaic device is disposed on the display panel of the mobile device, the interactive photovoltaic device enables the control circuit through the display panel light of the first predetermined area received by the solar panel, wherein the control circuit receives the optical signal through the optical signal receiver, and decodes the optical signal to obtain the interactive instruction inputted by the user.

In the interactive photovoltaic device and the interactive photovoltaic system according to a preferred embodiment of the present invention, the interactive photovoltaic device further comprises a first positioning member, a second positioning member and a third positioning member. The first positioning member is disposed on a third area of the bottom of the case. The second positioning member is disposed on a fourth area of the bottom of the case. The third positioning member is disposed on a fifth area of the bottom of the case. When the mobile device executes the interactive software, the mobile device correspondingly displays a first indicating area, a second indicating area and a third indicating area in correspondence with the first positioning member, the second positioning member and the third positioning member. The user determines a position, where the bottom of the case of the interactive photovoltaic device is disposed on the display panel of the mobile device, according to positions of the first indicating area, the second indicating area and the third indicating area.

In the interactive photovoltaic device and the interactive photovoltaic system according to a preferred embodiment of the present invention, the optical signal receiver comprises an opto-electronic diode and an amplifier circuit. The opto-electronic diode comprises an anode and a cathode, wherein the anode of the opto-electronic diode is coupled to the solar panel to receive the power voltage. The amplifier circuit comprises an input terminal and an output terminal, wherein the input terminal of the amplifier circuit is coupled to the cathode of the opto-electronic diode, and the output terminal of the amplifier circuit is coupled to the input/output port of the control circuit. In a preferred embodiment of the present invention, the amplifier circuit comprises a P-type transistor, a first resistor, a second resistor, a third resistor and a N-type transistor. The emitter of the P-type transistor is coupled to the anode of the opto-electronic diode, and the base of the P-type transistor is coupled to the cathode of the opto-electronic diode. The first terminal of the first resistor is coupled to the collector of the P-type transistor. The first terminal of the second resistor is coupled to the second terminal of the first resistor, and the second terminal of the second resistor is coupled to a common voltage. The first terminal of the third resistor is coupled to the emitter of the P-type transistor, and the second terminal of the third resistor is coupled to the input/output port of the control circuit. The emitter of the N-type transistor is coupled to the common voltage, the base of the N-type transistor is coupled to the second terminal of the first resistor, and the collector of the N-type transistor is coupled to the second terminal of the third resistor. In a preferred embodiment of the present invention, the mobile device is a tablet computer or a smart mobile phone.

The spirit of the present invention is to use the solar panel disposed on the bottom of the interactive device and to use the light, provided by the display panel of the tablet computer or the smart mobile phone device, as the electric power source. In addition, an optical communication receiver is additionally disposed on the bottom of the interactive device to receive the optical signals outputted from the display panel of the tablet computer or the smart mobile phone device so that the interaction with the user can be performed. Therefore, the interactive photovoltaic device and the mobile device can perform communication and control without any battery and connection wire.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1 is a schematic view showing an interactive photovoltaic system according to a preferred embodiment of the present invention.

FIG. 2A is a bottom view showing an interactive photovoltaic device 102 according to a preferred embodiment of the present invention.

FIG. 2B is a circuit block diagram showing the interactive photovoltaic device 102 according to a preferred embodiment of the present invention.

FIG. 3A is a top view showing a tablet computer 101 according to a preferred embodiment of the present invention.

FIG. 3B is a top view showing the tablet computer 101 according to a preferred embodiment of the present invention.

FIG. 4 is a bottom view showing the interactive photovoltaic device 102 according to a preferred embodiment of the present invention.

FIG. 5 is a top view showing the tablet computer 101 according to a preferred embodiment of the present invention.

FIG. 6A is a top view showing the tablet computer 101 according to a preferred embodiment of the present invention.

FIG. 6B is a top view showing the tablet computer 101 according to a preferred embodiment of the present invention.

FIG. 7 is a top view showing the tablet computer 101 according to a preferred embodiment of the present invention.

### DETAILED DESCRIPTION OF THE INVENTION

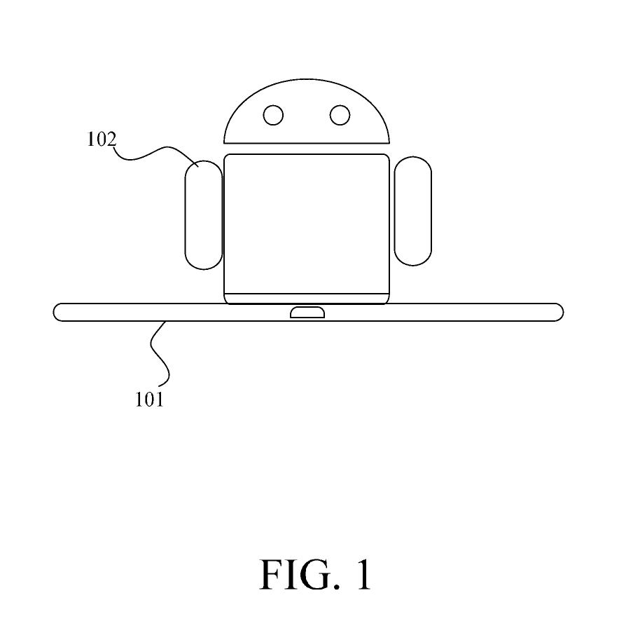

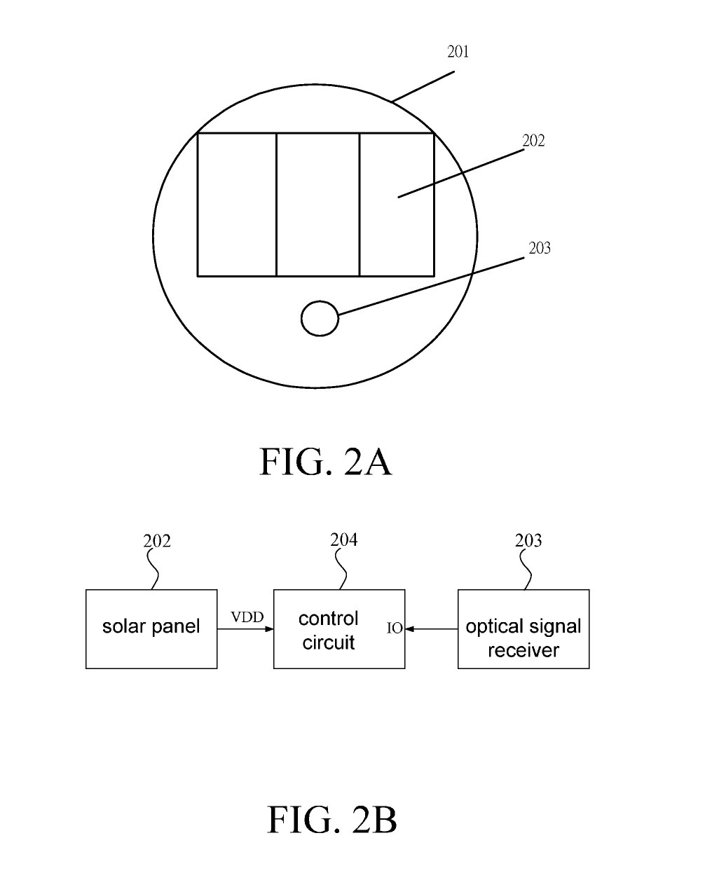

FIG. 1 is a schematic view showing an interactive photovoltaic system according to a preferred embodiment of the present invention. Referring to FIG. 1, the interactive photovoltaic system comprises a tablet computer 101 and an interactive photovoltaic device 102. In this embodiment, the interactive photovoltaic device 102 is disposed above the flat display panel of the tablet computer 101. In order to make those skilled in the art understand the present invention, the interactive photovoltaic device 102 in this embodiment is in the form of a robot. FIG. 2A is a bottom view showing the interactive photovoltaic device 102 according to a preferred embodiment of the present invention. Referring to FIG. 2A, the interactive photovoltaic device 102 comprises a casing bottom 201, a solar panel 202 and an optical signal receiver 203. FIG. 2B is a circuit block diagram showing the interactive photovoltaic device 102 according to a preferred embodiment of the present invention. Referring to FIG. 2B, the interactive photovoltaic device 102 of this embodiment comprises the solar panel 202, the optical signal receiver 203 and a control circuit 204. The electric power of the control circuit 204 is supplied from the solar panel 202.

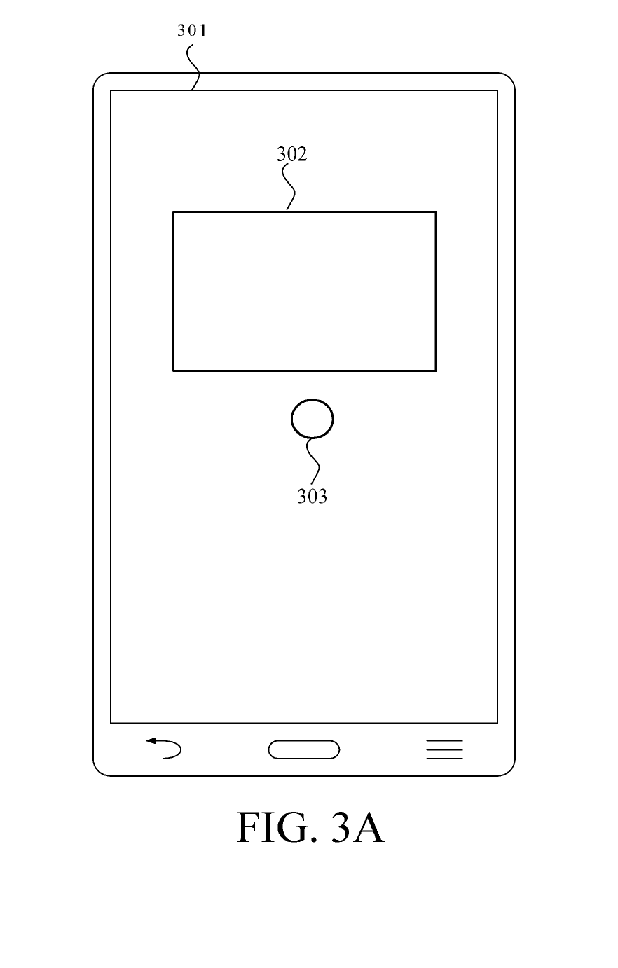

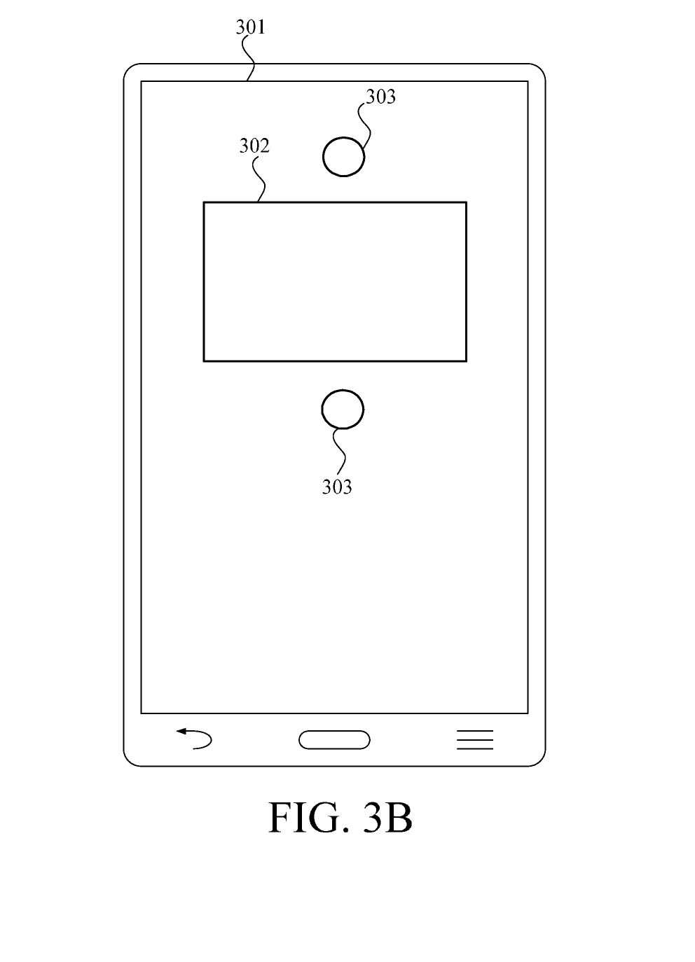

FIG. 3A is a top view showing a tablet computer 101 according to a preferred embodiment of the present invention. Referring to FIG. 3A, the tablet computer 101 comprises a flat display panel 301. When the user operates the tablet computer 101 to executes an interacting program and select an interactive instruction, a first predetermined area 302 of the flat display panel 301 is set as fully white, and a second predetermined area 303 of the flat display panel 301 outputs the optical signal to flicker according to the interactive instruction inputted by the user. When the user starts the operation, the user has to align the solar panel 202 on the bottom of the interactive photovoltaic device 102 with the first predetermined area 302 of the flat display panel of the tablet computer 101, and to align the optical signal receiver 203 on the bottom of the interactive photovoltaic device 102 with the second predetermined area 303 of the flat display panel 301 of the tablet computer 101.

When the interactive photovoltaic device 102 is disposed on the flat display panel 301 of the tablet computer 101, the interactive photovoltaic device 102 receives the white light from the second predetermined area through the solar panel 202, and generates a power voltage VDD to enable the control circuit 204. At this time, the control circuit 204 starts to receive the optical signal, received by the optical signal receiver 203, through its input/output port 10, and decodes the optical signal to obtain the interactive instruction inputted by the user. Thus, the user can control the operation, eye flicker or the like of the solar energy robot through the flat display panel 301 of the tablet computer.

In the above-mentioned embodiment, the first predetermined area 302 of the display panel outputs the full white is described as an example. However, those skilled in the art should understand that the image outputted from the first predetermined area 302 of the display panel needs not to be fully white, and may also be an ordinary picture as long as the picture is not dark or black. In other words, any picture having the brightness sufficient to enable the interactive photovoltaic device 102 falls within the scope of the present invention.

FIG. 3B is a top view showing the tablet computer 101 according to a preferred embodiment of the present invention. Referring to FIGS. 3A and 3B, the flat display panel 301 of the tablet computer 101 of FIG. 3A only has one second predetermined area 303 for outputting the optical signal. However, the flat display panel 301 of the tablet computer 101 of FIG. 3B has the two symmetrical second predetermined areas 303 for outputting the optical signal. In other words, even if the user places the solar energy robot upside down, the interactive photovoltaic system still can operate normally.

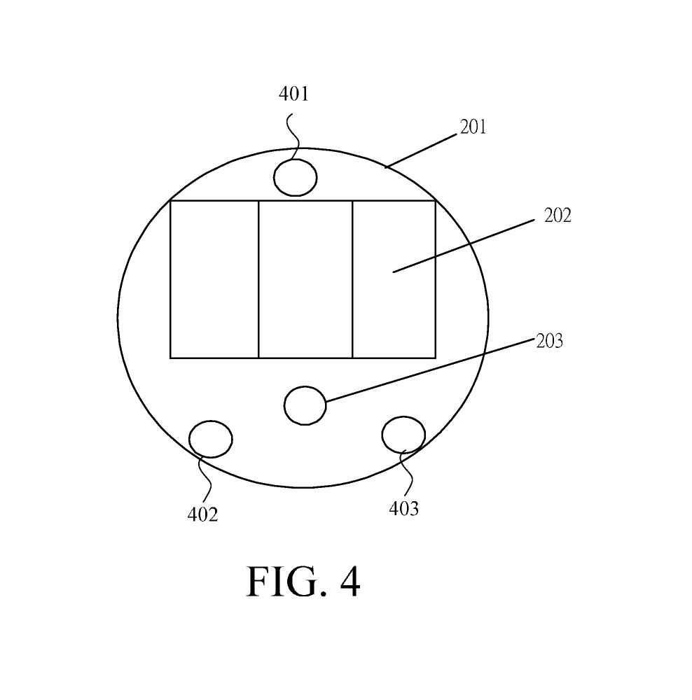

FIG. 4 is a bottom view showing the interactive photovoltaic device 102 according to a preferred embodiment of the present invention. Referring to FIG. 4, the interactive photovoltaic device 102 of this embodiment comprises a casing bottom 201, a solar panel 202 and an optical signal receiver 203, and further comprises a first positioning member 401, a second positioning member 402 and a third positioning member 403.

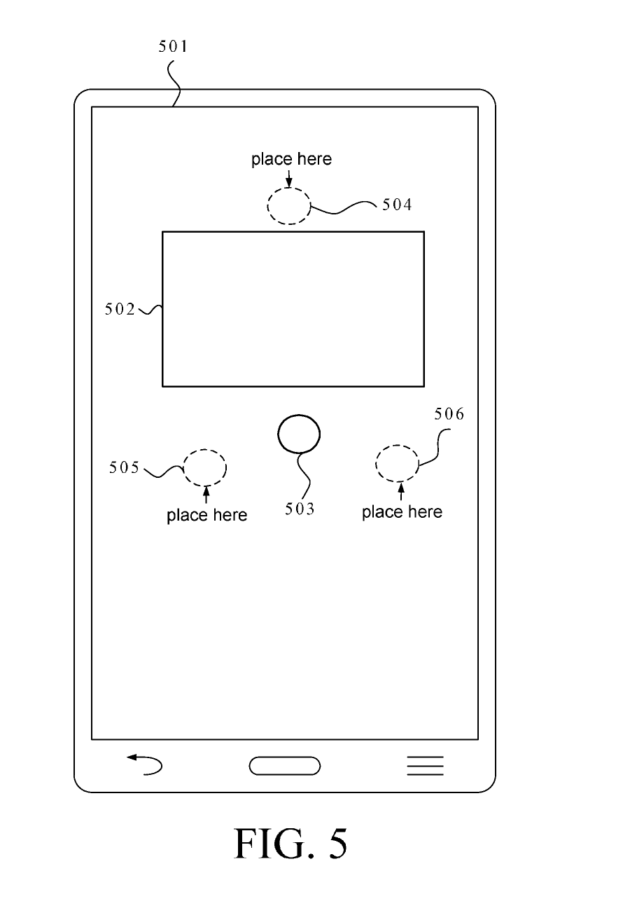

FIG. 5 is a top view showing the tablet computer 101 according to a preferred embodiment of the present invention. Referring to FIGS. 4 and 5, the tablet computer 101 comprises a flat display panel 501. When the user operates this tablet computer 101 to execute an interacting program and selects an interactive instruction, a first predetermined area 502 of the flat display panel 501 is set as fully white, and a second predetermined area 503 of the flat display panel 501 outputs the optical signal to flicker according to the interactive instruction inputted by the user. What is different from the embodiment of FIG. 3A or 3B is that a third predetermined area 504, a fourth predetermined area 505 and a fifth predetermined area 506 of the flat display panel 501 in this embodiment display indicating lines, and display the message “Place here” on the panel to guide the user to align the first positioning member 401, the second positioning member 402 and the third positioning member 403 on the bottom of the interactive photovoltaic device 102 of FIG. 4 with the third predetermined area 504, the fourth predetermined area 505 and the fifth predetermined area 506.

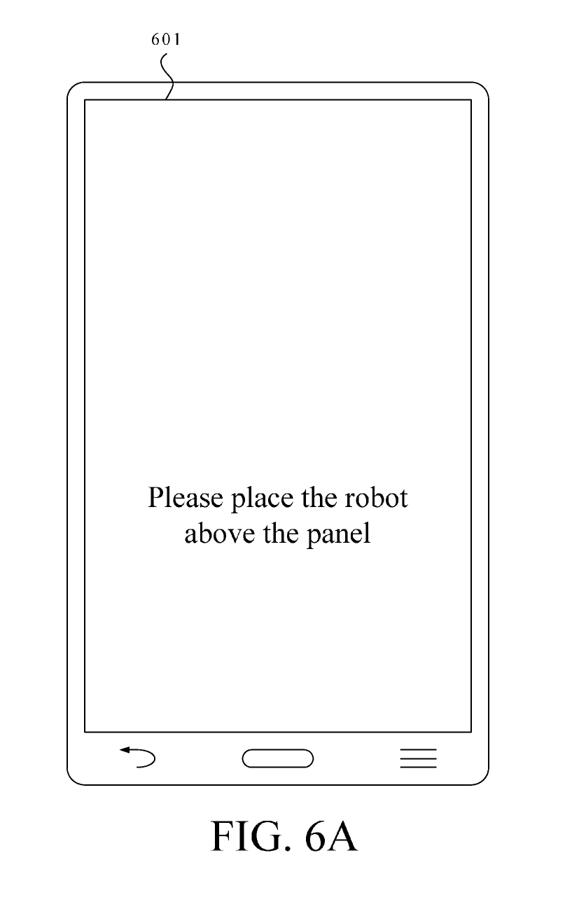

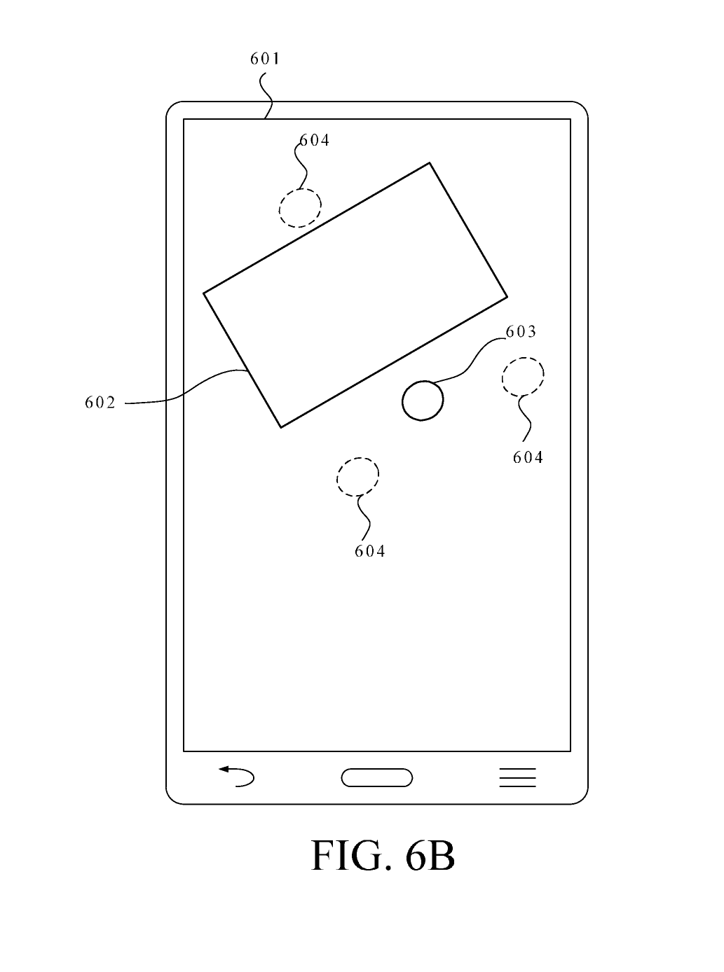

FIGS. 6A and 6B are top views showing the tablet computer 101 according to a preferred embodiment of the present invention. Referring first to FIG. 6A, it is assumed that the first positioning member 401, the second positioning member 402 and the third positioning member 403 of the interactive photovoltaic device 102 of FIG. 4 are conductor electrodes, that is, members 401 to 403 are made the material that can be detected by the capacitor touch panel. In addition, it is assumed that the tablet computer 101 has the capacitor touch panel. When the user operates the tablet computer 101 to execute an interacting program and selects an interactive instruction, the flat display panel 601 displays “Please place the robot above the panel”.

Referring next to FIG. 6B, when the interactive photovoltaic device 102 (robot) is placed, by the user, on the capacitor touch panel of the tablet computer 101, the tablet computer 101 automatically calculates the position and the angle of the first predetermined area 602, and the position and the angle of the second predetermined area 603 according to the three detected touch points 604. Thereafter, the first predetermined area 602 of the flat display panel 601 is set as fully white, and the second predetermined area 603 of the flat display panel 601 outputs the optical signal to flicker according to the interactive instruction inputted by the user.

In the above-mentioned embodiment, the first predetermined area 602 of the display panel outputs the full white is described as an example. However, those skilled in the art should understand that the image outputted from the first predetermined area 602 of the display panel needs not to be fully white, and may also be an ordinary picture as long as the picture is not dark or black. In other words, any picture having the brightness sufficient to enable the interactive photovoltaic device 102 falls within the scope of the present invention.

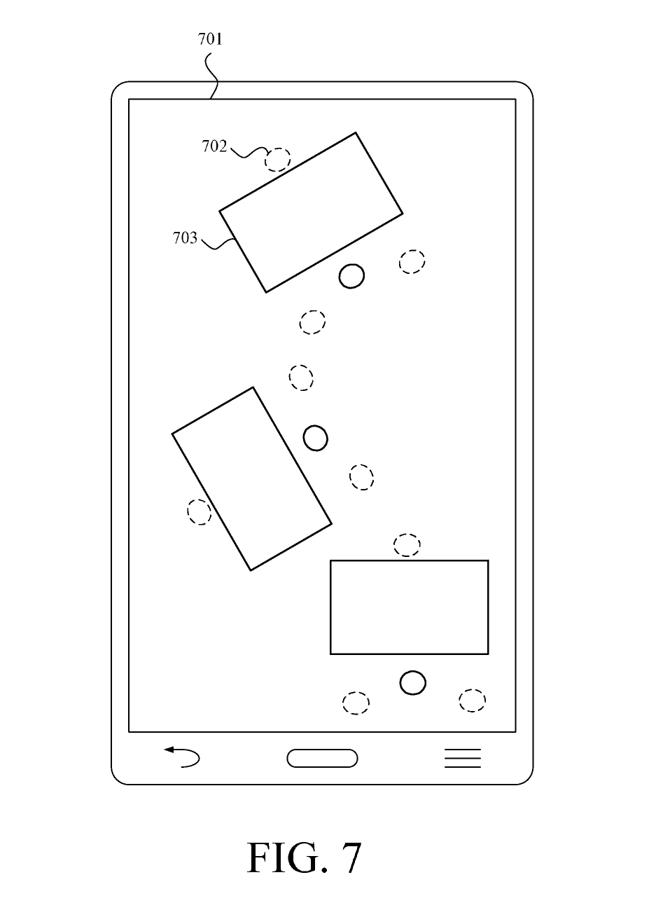

FIG. 7 is a top view showing the tablet computer 101 according to a preferred embodiment of the present invention. Referring to FIGS. 6B and 7, the difference between the embodiments of FIGS. 7 and 6B resides in that the embodiment of FIG. 7 has three interactive photovoltaic devices 102. Each interactive photovoltaic device has three positioning members 702, and the tablet computer can calculate the positions and the angles of the three predetermined areas 703 for receiving the display light on the display panel 701. Generally speaking, for the existing art, the tablet computer can achieve the 10-point touch. Therefore, as long as the interactive photovoltaic device 102 is designed to be small enough, or the display panel of the tablet computer is large enough, the interactive photovoltaic devices 102 can be controlled. Therefore, the present invention is not restricted thereto.

Similarly, the embodiment of FIG. 3A or 3B discloses the implementation of the single interactive photovoltaic device 102. However, those skilled in the art should understand that the embodiment of FIG. 3A or 3B may also control multiple interactive photovoltaic devices 102 concurrently after reviewing the description of the above-mentioned embodiments. Therefore, the present invention is not restricted thereto.

In summary, the spirit of the present invention is to dispose the solar panel on the bottom of the interactive device, and to use the light, provided by the flat display panel of the tablet computer or the smart mobile phone device as the electric power source of the interactive device. In addition, an optical communication receiver is additionally disposed on the bottom of the interactive device to receive the optical signal, outputted from the flat display panel of the tablet computer or the smart mobile phone device, to interact with the user. Thus, this interactive photovoltaic device can perform communication and control with the mobile device without any battery and connection wire.

In each embodiment mentioned hereinabove, although the tablet computer is described as an example, those skilled in the art should understand that the smart mobile phone, the tablet mobile phone or any other mobile device is applicable to the present invention. So, the present invention is not restricted thereto. In addition, although the flat display panel is described as an example in each embodiment, those skilled in the art should understand that a bendable display panel is also applicable to the present invention. So, the present invention is not restricted thereto.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An interactive photovoltaic device for communicating with a mobile device without any external power and battery, the mobile device having a display panel, and the interactive photovoltaic device comprising:
a case;
a solar panel disposed on the a first area of a bottom of the case;
an optical signal receiver disposed on the a second area of the bottom of the case; and
a control circuit comprising a power input terminal and an input/output port, wherein the power input terminal is coupled to the solar panel to receive a power voltage, and the input/output port is coupled to the optical signal receiver,
wherein when the mobile device executes interactive software, a first predetermined area of the display panel of the mobile device emits display panel light, and a second predetermined area of the display panel of the mobile device outputs an optical signal according to an interactive instruction inputted by a user,
wherein when the interactive photovoltaic device is disposed on the display panel of the mobile device, the interactive photovoltaic device enables the control circuit through the display panel light of the first predetermined area received by the solar panel,
wherein the control circuit receives the optical signal through the optical signal receiver, and decodes the optical signal to obtain the interactive instruction inputted by the user.

2. The interactive photovoltaic device according to claim 1, further comprising:
a first positioning member disposed on a third area of the bottom of the case;
a second positioning member disposed on a fourth area of the bottom of the case; and
a third positioning member disposed on a fifth area of the bottom of the case;
wherein when the mobile device executes the interactive software, the mobile device correspondingly displays a first indicating area, a second indicating area and a third indicating area in correspondence with the first positioning member, the second positioning member and the third positioning member,
wherein the user determines a position, where the bottom of the case of the interactive photovoltaic device is disposed on the display panel of the mobile device, according to positions of the first indicating area, the second indicating area and the third indicating area.

3. The interactive photovoltaic device according to claim 1, wherein the optical signal receiver comprises:
an opto-electronic diode comprising an anode and a cathode, wherein the anode of the opto-electronic diode is coupled to the solar panel to receive the power voltage; and
an amplifier circuit comprising an input terminal and an output terminal, wherein the input terminal of the amplifier circuit is coupled to the cathode of the opto-electronic diode, and the output terminal of the amplifier circuit is coupled to the input/output port of the control circuit.

4. The interactive photovoltaic device according to claim 3, wherein the amplifier circuit comprises:
a P-type transistor comprising a base, an emitter and a collector, wherein the emitter of the P-type transistor is coupled to the anode of the opto-electronic diode, and the base of the P-type transistor is coupled to the cathode of the opto-electronic diode;
a first resistor comprising a first terminal and a second terminal, wherein the first terminal of the first resistor is coupled to the collector of the P-type transistor;
a second resistor comprising a first terminal and a second terminal, wherein the first terminal of the second resistor is coupled to the second terminal of the first resistor, and the second terminal of the second resistor is coupled to a common voltage;
a third resistor comprising a first terminal and a second terminal, wherein the first terminal of the third resistor is coupled to the emitter of the P-type transistor, and the second terminal of the third resistor is coupled to the input/output port of the control circuit; and
a N-type transistor comprising a base, an emitter and a collector, wherein the emitter of the N-type transistor is coupled to the common voltage, the base of the N-type transistor is coupled to the second terminal of the first resistor, and the collector of the N-type transistor is coupled to the second terminal of the third resistor.

5. The interactive photovoltaic device according to claim 1, wherein the mobile device is a tablet computer.

6. The interactive photovoltaic device according to claim 1, wherein the mobile device is a smart mobile phone.

7. The interactive photovoltaic device according to claim 1, further comprising:
a first conductor electrode disposed on a third area of the bottom of the case;
a second conductor electrode disposed on a fourth area of the bottom of the case; and
a third conductor electrode disposed on a fifth area of the bottom of the case;
wherein the display panel of the mobile device has a capacitor sensing surface plate, wherein when the interactive photovoltaic device is disposed on the capacitor sensing surface plate of the mobile device, positions of the first conductor electrode, the second conductor electrode and the third conductor electrode are sensed,
wherein when the mobile device executes the interactive software, the mobile device correspondingly adjusts display positions and angles of the first predetermined area and the second predetermined area in correspondence with the positions of the first conductor electrode, the second conductor electrode and the third conductor electrode.

8. An interactive photovoltaic system, comprising:
a mobile device having a display panel; and
an interactive photovoltaic device for communicating with the mobile device without any external power and battery, the interactive photovoltaic device comprising:
a case;
a solar panel disposed on a first area of a bottom of the case;
an optical signal receiver disposed on a second area of the bottom of the case; and
a control circuit comprising a power input terminal and an input/output port, wherein the power input terminal is coupled to the solar panel to receive a power voltage, and the input/output port is coupled to the optical signal receiver,
wherein when the mobile device executes interactive software, a first predetermined area of the display panel of the mobile device emits display panel light, and a second predetermined area of the display panel of the mobile device outputs an optical signal according to an interactive instruction inputted by a user,
wherein when the interactive photovoltaic device is disposed on the display panel of the mobile device, the interactive photovoltaic device enables the control circuit through the display panel light of the first predetermined area received by the solar panel,
wherein the control circuit receives the optical signal through the optical signal receiver, and decodes the optical signal to obtain the interactive instruction inputted by the user.

9. The interactive photovoltaic system according to claim 8, wherein the interactive photovoltaic device further comprises:
a first positioning member disposed on a third area of the bottom of the case;
a second positioning member disposed on a fourth area of the bottom of the case; and
a third positioning member disposed on a fifth area of the bottom of the case;
wherein when the mobile device executes the interactive software, the mobile device correspondingly displays a first indicating area, a second indicating area and a third indicating area in correspondence with the first positioning member, the second positioning member and the third positioning member,
wherein the user determines a position, where the bottom of the case of the interactive photovoltaic device is disposed on the display panel of the mobile device, according to positions of the first indicating area, the second indicating area and the third indicating area.

10. The interactive photovoltaic system according to claim 8, wherein the optical signal receiver comprises:
an opto-electronic diode comprising an anode and a cathode, wherein the anode of the opto-electronic diode is coupled to the solar panel to receive the power voltage; and
an amplifier circuit comprising an input terminal and an output terminal, wherein the input terminal of the amplifier circuit is coupled to the cathode of the opto-electronic diode, and the output terminal of the amplifier circuit is coupled to the input/output port of the control circuit.

11. The interactive photovoltaic system according to claim 10, wherein the amplifier circuit comprises:
a P-type transistor comprising a base, an emitter and a collector, wherein the emitter of the P-type transistor is coupled to the anode of the opto-electronic diode, and the base of the P-type transistor is coupled to the cathode of the opto-electronic diode;
a first resistor comprising a first terminal and a second terminal, wherein the first terminal of the first resistor is coupled to the collector of the P-type transistor;
a second resistor comprising a first terminal and a second terminal, wherein the first terminal of the second resistor is coupled to the second terminal of the first resistor, and the second terminal of the second resistor is coupled to a common voltage;
a third resistor comprising a first terminal and a second terminal, wherein the first terminal of the third resistor is coupled to the emitter of the P-type transistor, and the second terminal of the third resistor is coupled to the input/output port of the control circuit; and
a N-type transistor comprising a base, an emitter and a collector, wherein the emitter of the N-type transistor is coupled to the common voltage, the base of the N-type transistor is coupled to the second terminal of the first resistor, and the collector of the N-type transistor is coupled to the second terminal of the third resistor.

12. The interactive photovoltaic system according to claim 8, wherein the mobile device is a tablet computer.

13. The interactive photovoltaic system according to claim 8, wherein the mobile device is a smart mobile phone.

14. The interactive photovoltaic system according to claim 8, wherein the interactive photovoltaic device further comprises:
a first conductor electrode disposed on a third area of the bottom of the case;
a second conductor electrode disposed on a fourth area of the bottom of the case; and
a third conductor electrode disposed on a fifth area of the bottom of the case;
wherein the display panel of the mobile device has a capacitor sensing surface plate, wherein when the interactive photovoltaic device is disposed on the capacitor sensing surface plate of the mobile device, positions of the first conductor electrode, the second conductor electrode and the third conductor electrode are sensed,
wherein when the mobile device executes the interactive software, the mobile device correspondingly adjusts display positions and angles of the first predetermined area and the second predetermined area in correspondence with the positions of the first conductor electrode, the second conductor electrode and the third conductor electrode.

15. The interactive photovoltaic system according to claim 8, further comprising:
a second interactive photovoltaic device, comprising:
a second case;
a second solar panel disposed on a first area of a bottom of the second case;
a second optical signal receiver disposed on a second area of the bottom of the second case; and
a second control circuit comprising a power input terminal and an input/output port, wherein the power input terminal of the second control circuit is coupled to the solar panel to receive a power voltage, and the input/output port of the second control circuit is coupled to the second optical signal receiver,
wherein when the mobile device executes interactive software, a third predetermined area of the display panel of the mobile device emits display panel light, and a fourth predetermined area of the display panel of the mobile device outputs a second optical signal according to an interactive instruction inputted by a user,
wherein when the second interactive photovoltaic device is disposed on the display panel of the mobile device, the second interactive photovoltaic device enables the second control circuit through the display panel light of the third predetermined area received by the solar panel,
wherein the second control circuit receives the second optical signal through the second optical signal receiver, and decodes the optical signal to obtain the interactive instruction inputted by the user.
